(19) United States
(12) Patent Application Publication
(10) Pub. No.: US 2006/0054595 A1
(43) Pub. Date: Mar. 16, 2006

(54) Selective hafnium oxide etchant

(75) Inventor: John Starzynski, Brooklyn Park, MN (US)

Correspondence Address: BINGHAM, MCCUTCHEN LLP, THREE EMBARCADERO CENTER, 18 FLOOR, SAN FRANCISCO, CA, 94111-4067, US

(73) Assignee: HONEYWELL INTERNATIONAL INC.

(21) Appl. No.: 10/938,191

(22) Filed: Sep. 10, 2004

(51) Int. Cl. C03C 15/00; B44C 1/22; C09K 13/04

(52) U.S. Cl. 216/57; 252/79.1; 252/79.2; 216/83

(57) ABSTRACT

An etchant is provided. The etchant includes 0.1 weight percent to 10 weight percent HF; 0 weight percent to 2 weight percent HCl; 0 weight percent to 5 weight percent H2O; and a balance of a solvent less polar than water. In one embodiment, the solvent less polar than water is propylene carbonate. A method of using the etchant is also provided.

### BACKGROUND OF THE INVENTION

1. Field of the Invention

This invention relates generally to semiconductor manufacturing and, in particular, to an etchant capable of etching a high k dielectric.

2. Description of the Related Art

As transistor dimensions continue to shrink, the channel length (the distance between the source and the drain) will shrink as well. A shorter channel means faster transition switching because the charger carriers have a shorter distance to travel. However, it becomes harder for the gate to maintain control over the channel. Instead, the voltage on the drain begins to lower the energy barrier in the channel, reducing the threshold voltage and freeing carriers to flow even when there is no voltage on the gate. This is referred to as the short-channel effect and causes power consumption to rise and ultimately destroys transistor-switching action completely.

Ideally, the gate controls or holds electrons in the channels strictly through capacitive coupling, being separated from the channel by an oxide insulating barrier immune to the passage of charge carriers. However, for the 90 nanometer node and below, the thickness of the gate oxide is shrinking to less than 2 nanometers. An oxide this thin allows a significant amount of current to flow from gate to channel substrate. One solution to this problem is the replacement of the gate insulation, silicon dioxide, with the material having a larger dielectric constant. Thus, a gate over a thick, high-k insulator can control the channel just as effectively as one over a thinner lower-k insulator. One promising candidate is hafnium dioxide, whose dielectric constant (k) of about 22 allows the gate to control the channel despite the oxide being several times thicker than silicon dioxide.

During the semiconductor manufacturing process, once the transistor gate is formed the exposed stack must be removed from the source and drain regions of the transistor. Thus, when using hafnium dioxide as the gate oxide, the hafnium dioxide must be removed. As dry etching techniques rely on the formation of volatile compounds, there are no viable dry etching techniques suitable for the removal of the hafnium dioxide, as no volatile hafnium (Hf) compounds exist. Therefore, the hafnium dioxide will have to be removed through wet etching. Current etchants for wet etching, e.g., hydrofluoric acid (HF) solutions, do not possess the requisite etch selectivity between hafnium dioxide and thermally grown silicon dioxide and silicon dioxide formed by the decomposition of tetraethylorthosilicate (TEOS), which may be present on the semiconductor substrate.

As a result, there is a need to solve the problems of the prior art to provide a hafnium dioxide etchant that is selective to silicon dioxides such as thermal oxide or TEOS based oxide.

### SUMMARY OF THE INVENTION

Broadly speaking, the present invention fills these needs by providing a method and an etchant for etching a high k dielectric layer. It should be appreciated that the present invention can be implemented in numerous ways, including as a solution and a method of using the solution. Several inventive embodiments of the present invention are described below.

In one aspect of the invention an etchant is provided. The etchant consists essentially of about 0.1 weight percent to about 10 weight percent HF; about 0 weight percent to about 2 weight percent HCl; about 0 weight percent to about 5 weight percent H₂O; and a balance of a solvent less polar than water. In one embodiment, the solvent less polar than water is propylene carbonate. In another embodiment, the solvent is non-polar.

In another aspect of the invention, a method for etching a dielectric is provided. The method initiates with sputter etching a portion of a dielectric film disposed over a substrate. Then a wet etchant including a solvent less polar than water is applied to remove a remaining portion of the dielectric film. In one embodiment, approximately half of the dielectric film is removed through the sputter etching operation. In another embodiment, the dielectric film is hafnium dioxide. In yet another embodiment, the sputter etching is performed with an argon based plasma.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIGS. 1A and 1B are graphs illustrating the effect on the hafnium dioxide etch rate when the hydrochloric acid weight percent decreases in accordance with one embodiment of the invention.

FIGS. 2A and 2B are graphs illustrating the effect on the hafnium dioxide/thermal oxide etch selectivity with changes in HF concentration in accordance with one embodiment of the invention.

FIGS. 3A and 3B are graphs illustrating the effect on the hafnium dioxide/TEOS etch selectivity with changes in the HCl and H₂O concentration in accordance with one embodiment of the invention.

### DETAILED DESCRIPTION OF THE PREFERRED EMBODIMENTS

An invention is described for a composition of a wet etchant and a method of use of that etchant. It will be obvious, however, to one skilled in the art, that the present invention may be practiced without some or all of these specific details. In other instances, well known process operations have not been described in detail in order not to unnecessarily obscure the present invention.

An etchant for wet etching integrated circuit devices incorporating a high dielectric constant (high-k) film, such as hafnium dioxide (HfO₂), is described below. The wet etchant is highly selective to silicon, tetraethylorthosilicate (TEOS), and thermal oxide. In addition, the wet etchant is highly selective to Si₃N₄, silicides, and/or metals such as tungsten. In one embodiment, the etchant is a solution of hydrofluoric acid, hydrochloric acid and water at relatively low concentrations, i.e., less than 2% weight percent for each component. The remainder of the solution is a non-polar solvent or a solvent that is less polar than water. As used herein, the term “non-polar” refers to a characteristic of a molecule or compound that creates a substantially equal charge, partial charge or spontaneous charge distribution at one point of the molecule or compound or along the molecule or compound. One of ordinary skill in the art of chemistry and etching solutions will know which solvents are characterized as non-polar or less polar than water and which solvents are clearly as polar or more polar than water in nature.

In some contemplated embodiments, the solvent or solvent mixture (comprising at least two solvents) includes those solvents that are considered part of the hydrocarbon family of solvents. Hydrocarbon solvents are those solvents that comprise carbon and hydrogen. It should be understood that a majority of hydrocarbon solvents are non-polar, and therefore less polar than water; however, there are a few hydrocarbon solvents that could be considered to be as polar or more polar than water. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, fluorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof.

In other contemplated embodiments, the solvent or solvent mixture may comprise those solvents that are not considered part of the hydrocarbon solvent family of compounds, such as ketones, which include fluorinated ketones, e.g., acetone, diethyl ketone, methyl ethyl ketone and the like, alcohols, which include fluorinated alcohols, esters, which include fluorinated esters, fluorinated and non-fluorinated carbonate-based compounds, such as propylene carbonate and the like, ethers, which include fluorinated ethers, and amines, which include fluorinated amines. In yet other contemplated embodiments, the solvent or solvent mixture may comprise a combination of any of the solvents mentioned herein.

In one embodiment, the etch selectivity of the etchant, with respect to the above-mentioned components, may be modified by adjusting the weight percent of water in the solution. Exemplary ranges of the components of the etchant solution are provided in TABLE 1.

TABLE 1

| Factor | High | Middle | Low |
|---|---|---|---|
| HF conc. (w/0) | 0.85 | 0.71 | 0.57 |
| HCl conc. (w/0) | 0.23 | 0.19 | 0.15 |
| H₂O conc. (w/0) | 1.27 | 1.06 | 0.85 |

TABLE 1 illustrates the exemplary concentrations in weight percent for the components of the wet etchant in accordance with one embodiment of the invention. The hydrofluoric acid (HF) concentration is shown ranging from a low weight percent of 0.57 to a high weight percent of 0.85. The hydrochloric acid (HCl) concentration ranges from 0.15 weight percent to 0.23 weight percent. The water (H₂O) concentration ranges from 0.85 weight percent td 1.27 weight percent. The remainder of the solution is made up of a non-polar solvent or a solvent less polar than water, selected from the group consisting of hydrocarbon solvents including toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons or fluorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof. In other contemplated embodiments, the solvent or solvent mixture may comprise those solvents that are not considered part of the hydrocarbon solvent family of compounds, such as fluorinated and non-fluorinated ketones, e.g., acetone, diethyl ketone, methyl ethyl ketone and the like, alcohols, which include fluorinated alcohols, esters, which include fluorinated esters, fluorinated and non-fluorinated carbonate-based compounds, such as propylene carbonate and the like, ethers, which include fluorinated ethers, and amines. In yet other contemplated embodiments, the solvent or solvent mixture may comprise a combination of any of the solvents mentioned herein. It should be appreciated that the ranges listed in TABLE 1 are exemplary and not meant to be limiting. For example, the range for HF may be extended to about 0.1% to about 10%. Likewise the range for the HCl and the H₂O may be extended to about 0% to about 2%, and about 0% to about 5%, respectively.

Propylene carbonate is a preferred solvent less polar than water, as the propylene carbonate is less volatile, e.g., has a higher flashpoint, than lightweight alcohols and less polar than lightweight alcohols. As a result of the higher flashpoint, the process temperature may be at room temperature, i.e., approximately 20 Celsius (C), or above. In one embodiment, the process temperature for the wet etchant application is between about −10 C and about 50 C. It should be appreciated that the non-polar solvent, slightly polar solvent or solvent less polar than water, enables more of the HF to remain in a non-dissociated form. In contrast, an aqueous solution of dilute HF results in most of the HF to dissociate into H⁺ and F⁻ ions. In the presence of a strong acid, bifluoride ions (HF₂⁻) also form. Dilute HF chemistries in water will etch hafnium dioxide but have no etch selectivity to silicon dioxide. However, by decreasing or minimizing the HF₂⁻ concentration in the etchant, the silicon dioxide etch rate may be suppressed, thereby providing the etch selectivity required for the use of a wet etchant to be applied to remove the hafnium dioxide.

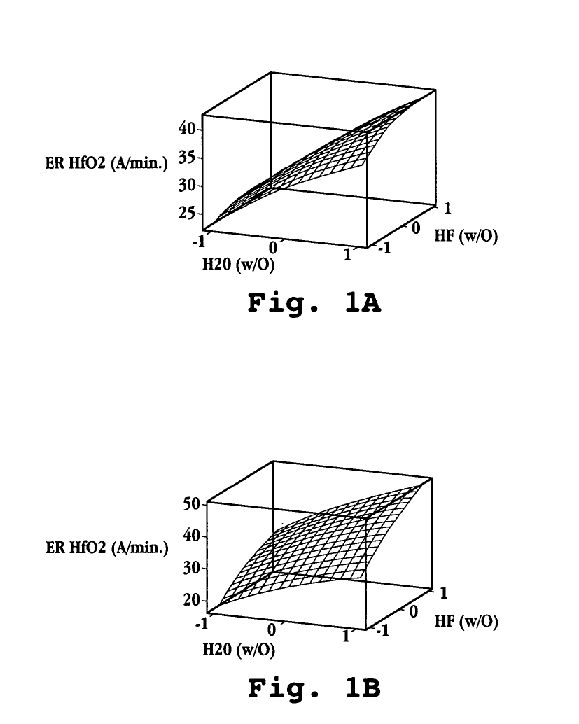

FIGS. 1A and 1B are graphs illustrating the effect on the hafnium dioxide etch rate when the hydrochloric acid weight percent decreases in accordance with one embodiment of the invention. In FIG. 1A the HCl concentration is held at the high held factor, i.e., 0.23 weight percent. In FIG. 1B the HCl concentration is held at the low held factor, i.e., 0.15 weight percent. As shown by comparing FIGS. 1A and 1B, the hafnium dioxide etch rate increases as the HCl concentration decreases. It should be appreciated that the −1, 0, and 1 locations on the axes of FIGS. 1A-3B represent the low, middle, and high factors of TABLE 1 for the corresponding component. Thus, with reference to FIG. 1A, the −1 location for the H₂O weight percent corresponds to the 0.85 weight percent of TABLE 1, the 0 location for the H₂O weight percent corresponds to the 1.06 weight percent of TABLE 1, and so on. The etch rates of Tables 1A and 1B were measured using a reflectometer when using unpatterned wafers and a profilometer when using patterned wafers.

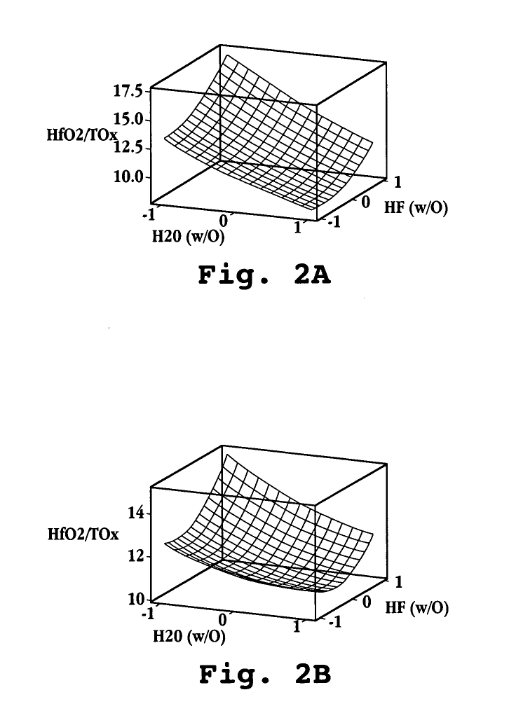

FIGS. 2A and 2B are graphs illustrating the effect on the hafnium dioxide/thermal oxide etch selectivity with changes in HF concentration in accordance with one embodiment of the invention. In FIG. 2A the HF concentration is held at the high held factor, i.e., 0.85 weight percent. In FIG. 2B the HF concentration is held at the low held factor, i.e., 0.57 weight percent. As shown by comparing FIGS. 2A and 2B, the hafnium dioxide/thermal oxide etch selectivity increases as the HF concentration increases.

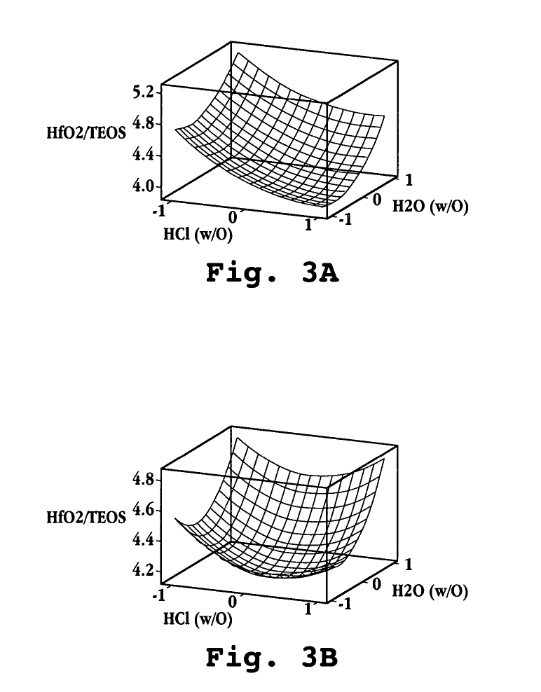

FIGS. 3A and 3B are graphs illustrating the effect on the hafnium dioxide/TEOS etch selectivity with changes in the HCI and the H₂O concentration in accordance with one embodiment of the invention. In FIG. 3A the HF concentration is held at the high held factor, i.e., 0.85 weight percent. In FIG. 2B the HF concentration is held at the mid held factor, i.e., 0.71 weight percent. As shown by comparing FIGS. 3A and 3B, the hafnium dioxide/TEOS etch selectivity increases as the HF concentration increases. Furthermore, within FIGS. 3A and 3B, the hafnium dioxide/TEOS etch selectivity increases with increasing water concentration and decreasing HCl concentration.

It should be appreciated that the etchant composition described above may also be used in a method for etching a semiconductor substrate having a high k dielectric, such as hafnium dioxide. The method would include a two step etch process where the first step is a dry etch and the second step is a wet etch using the etchant described herein. The first step includes sputter etching with a plasma having a heavy positive ion, e.g., an Argon based plasma. Here, approximately 50% of the hafnium dioxide film is removed. In one embodiment, the hafnium dioxide film is approximately 100 Å thick, therefore, approximately 50 Å of this layer is removed through the sputter etch step. It should be appreciated that the sputter etch process may be performed through any suitable sputter etch chamber. Most of the remaining 50 Å of the hafnium dioxide layer will be damaged by the sputter etch process, thereby making it easier for the second step, i.e., the wet etch process, to remove the remaining hafnium dioxide layer.

Following the sputter etch process, the wet etchant solution described above is applied to the semiconductor substrate to remove the remaining portion of the hafnium dioxide layer. Thus, the plasma etch initiates the two step process and provides for an anisotropic etch which damages the remaining layer of hafnium dioxide. Thereafter, the wet etchant is applied and the enhanced etch selectivity enabled through the non-polar solvent (as mentioned above, a solvent less polar than water may alternatively be used) removes the remaining portion of the hafnium dioxide layer without causing notches, i.e., providing a desirable sidewall profile. In addition, the enhanced etch selectivity prevents etching through the silicon dioxide/thermal oxide.

In summary, the above-described invention provides a wet etchant and a method of using the wet etchant for a semiconductor fabrication process using a high k dielectric such as hafnium dioxide. By preventing the dissociation of HF through the use of a non-polar solvent, or a solvent less polar than water, the wet etchant becomes highly selective to silicon, TEOS, thermal oxide, Si₃N₄, suicides, and metals, such as, for example, tungsten. In one embodiment the etch rate is between about 5 to 25 angstroms per minute. In another embodiment the wet etchant described herein is metal free. Furthermore, because the wet etchant composition described above is nonvolatile, the composition is relatively safe as compared to other available wet etchants. It should be appreciated that solvents less polar than water include slightly polar solvents. Of course, non-polar solvents are less polar than water.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. An etchant, comprising:
0.1 weight percent to 10 weight percent HF;
0 weight percent to 2 weight percent HCl;
0 weight percent to 5 weight percent H₂O; and
a balance of a solvent less polar than water.

2. The etchant of claim 1, wherein the solvent less polar than water is propylene carbonate.

3. The etchant of claim 1, wherein the solvent less polar than water is selected from the group consisting of an aromatic hydrocarbon solvent, an aliphatic hydrocarbon solvent, a cyclic hydrocarbon solvent, a ketone solvent, a carbonate based solvent, a halogenated hydrocarbon solvent, an alcohol solvent, an ester solvent, an ether solvent, an amine solvent, and mixtures thereof.

4. The ethchant of claim 3, wherein the aromatic hydrocarbon solvent is selected from the group consisting of toluene, xylene, p-xylene, m-xylene, mesitylene, solvent naphtha H, benzene, 1,2-dimethylbenzene, 1,2,4-trimethylbenzene, isobutylbenzene, ethyltoluene and mixtures thereof.

5. The ethchant of claim 3, wherein the aliphatic hydrocarbon solvent is selected from the group consisting of pentane, hexane, isohexane, heptane, nonane, octane, dodecane, 2-methylbutane, hexadecane, tridecane, pentadecane, 2,2,4-trimethylpentane, petroleum ethers, solvent naphtha A and mixtures thereof.

6. The ethchant of claim 3, wherein the cyclic hydrocarbon solvent is selected from the group consisting of cyclopentane, cyclohexane, cycloheptane, cyclooctane, cyclononane, cyclododecane, cyclohexadecane, cyclotridecane, cyclopentadecane and mixtures thereof.

7. The etchant of claim 3, wherein the ketone solvent is selected from the group consisting of acetone, diethyl ketone, and methyl ethyl ketone and mixtures thereof.

8. The etchant of claim 3, wherein the halogenated hydrocarbon solvent is selected from the group consisting of a chlorinated hydrocarbon solvent, a fluorinated hydrocarbon solvent, and a nitrated hydrocarbon solvent and mixtures thereof.

9. The etchant of claim 1, wherein the weight percent of HF is between 0.5 and 0.85.

10. The etchant of claim 1, wherein the weight percent of HCl is between 0.15 and 0.25.

11. The etchant of claim 1, wherein the weight percent of H₂O is between 0.1 and 5.

12. An etchant, comprising:
0.1 weight percent to 10 weight percent HF;
0.15 weight percent to 0.25 weight percent HCl;
0.85 weight percent to 1.25 weight percent H₂O; and
a balance of a solvent less polar than water.

13. The etchant of claim 12, wherein the solvent less polar than water is propylene carbonate.

14. The etchant of claim 12, wherein the solvent less polar than water is selected from the group consisting of an aromatic hydrocarbon solvent, an aliphatic hydrocarbon solvent, a cyclic hydrocarbon solvent, a ketone solvent, a carbonate based solvent, a halogenated hydrocarbon solvent, an alcohol solvent, an ester solvent, an ether solvent, an amine solvent, and mixtures thereof.

15. The ethchant of claim 14, wherein the aromatic hydrocarbon solvent is selected from the group consisting of toluene, xylene, p-xylene, m-xylene, mesitylene, solvent naphtha H, benzene, 1,2-dimethylbenzene, 1,2,4-trimethylbenzene, isobutylbenzene, ethyltoluene and mixtures thereof.

16. The ethchant of claim 14, wherein the aliphatic hydrocarbon solvent is selected from the group consisting of pentane, hexane, isohexane, heptane, nonane, octane, dodecane, 2-methylbutane, hexadecane, tridecane, pentadecane, 2,2,4-trimethylpentane, petroleum ethers, solvent naphtha A and mixtures thereof.

17. The ethchant of claim 14, wherein the cyclic hydrocarbon solvent is selected from the group consisting of cyclopentane, cyclohexane, cycloheptane, cyclooctane, cyclononane, cyclododecane, cyclohexadecane, cyclotridecane, cyclopentadecane and mixtures thereof.

18. The etchant of claim 14, wherein the ketone solvent is selected from the group consisting of acetone, diethyl ketone, and methyl ethyl ketone and mixtures thereof.

19. The etchant of claim 14, wherein the halogenated hydrocarbon solvent is selected from the group consisting of a chlorinated hydrocarbon solvent, a fluorinated hydrocarbon solvent, and a nitrated hydrocarbon solvent and mixtures thereof.

20. The etchant of claim 12, wherein the weight percent of HF is between 0.5 and 0.85.

21. An etchant, consisting essentially of:
0.1 weight percent to 10 weight percent HF;
0 weight percent to 2 weight percent HCl;
0 weight percent to 5 weight percent H₂O; and
a balance of a non-polar solvent.

22. The etchant of claim 21, wherein the non-polar solvent is propylene carbonate.

23. The etchant of claim 21, wherein the non-polar solvent is selected from the group consisting of an aromatic hydrocarbon solvent, an aliphatic hydrocarbon solvent, a cyclic hydrocarbon solvent, a ketone solvent, a carbonate based solvent, a halogenated hydrocarbon solvent, an alcohol solvent, an ester solvent, an ether solvent, an amine solvent, and mixtures thereof.

24. The ethchant of claim 23, wherein the aromatic hydrocarbon solvent is selected from the group consisting of toluene, xylene, p-xylene, m-xylene, mesitylene, solvent naphtha H, benzene, 1,2-dimethylbenzene, 1,2,4-trimethylbenzene, isobutylbenzene, ethyltoluene and mixtures thereof.

25. The ethchant of claim 23, wherein the aliphatic hydrocarbon solvent is selected from the group consisting of pentane, hexane, isohexane, heptane, nonane, octane, dodecane, 2-methylbutane, hexadecane, tridecane, pentadecane, 2,2,4-trimethylpentane, petroleum ethers, solvent naphtha A and mixtures thereof.

26. The ethchant of claim 23, wherein the cyclic hydrocarbon solvent is selected from the group consisting of cyclopentane, cyclohexane, cycloheptane, cyclooctane, cyclononane, cyclododecane, cyclohexadecane, cyclotridecane, cyclopentadecane and mixtures thereof.

27. The etchant of claim 23, wherein the ketone solvent is selected from the group consisting of acetone, diethyl ketone, and methyl ethyl ketone and mixtures thereof.

28. The etchant of claim 23, wherein the halogenated hydrocarbon solvent is selected from the group consisting of a chlorinated hydrocarbon solvent, a fluorinated hydrocarbon solvent, and a nitrated hydrocarbon solvent and mixtures thereof.

29. The etchant of claim 21, wherein the weight percent of HF is between 0.5 and 0.85.

30. The etchant of claim 21, wherein the weight percent of HCl is between 0.15 and 0.25.

31. The etchant of claim 21, wherein the weight percent of H₂O is between 0.1 and 5.

32. An etchant, consisting essentially of:
0.1 weight percent to 10 weight percent HF;
0.15 weight percent to 0.25 weight percent HCl;
0.85 weight percent to 1.25 weight percent H₂O; and
a balance of a non-polar solvent.

33. The etchant of claim 32, wherein the non-polar solvent is propylene carbonate.

34. The etchant of claim 31, wherein the non-polar solvent is selected from the group consisting of an aromatic hydrocarbon solvent, an aliphatic hydrocarbon solvent, a cyclic hydrocarbon solvent, a ketone solvent, a carbonate based solvent, a halogenated hydrocarbon solvent, an alcohol solvent, an ester solvent, an ether solvent, an amine solvent, and mixtures thereof.

35. The ethchant of claim 34, wherein the aromatic hydrocarbon solvent is selected from the group consisting of toluene, xylene, p-xylene, m-xylene, mesitylene, solvent naphtha H, benzene, 1,2-dimethylbenzene, 1,2,4-trimethylbenzene, isobutylbenzene, ethyltoluene and mixtures thereof.

36. The ethchant of claim 34, wherein the aliphatic hydrocarbon solvent is selected from the group consisting of pentane, hexane, isohexane, heptane, nonane, octane, dodecane, 2-methylbutane, hexadecane, tridecane, pentadecane, 2,2,4-trimethylpentane, petroleum ethers, solvent naphtha A and mixtures thereof.

37. The ethchant of claim 34, wherein the cyclic hydrocarbon solvent is selected from the group consisting of cyclopentane, cyclohexane, cycloheptane, cyclooctane, cyclononane, cyclododecane, cyclohexadecane, cyclotridecane, cyclopentadecane and mixtures thereof.

38. The etchant of claim 34, wherein the ketone solvent is selected from the group consisting of acetone, diethyl ketone, and methyl ethyl ketone and mixtures thereof.

39. The etchant of claim 34, wherein the halogenated hydrocarbon solvent is selected from the group consisting of a chlorinated hydrocarbon solvent, a fluorinated hydrocarbon solvent, and a nitrated hydrocarbon solvent and mixtures thereof.

40. The etchant of claim 32, wherein the weight percent of HF is between 0.5 and 0.85.

41. A method for etching a dielectric, comprising the operations of:
sputter etching a portion of a dielectric film disposed over a substrate; and
applying a wet etchant including a solvent less polar than water to remove a remaining portion of the dielectric film.

42. The method of claim 41, wherein the method operation of sputter etching a portion of a dielectric film disposed over a substrate includes,
removing approximately half of the dielectric film.

43. The method of claim 41, wherein the wet etchant includes HF and HCl.

44. The method of claim 43, wherein the wet etchant includes water.

45. The method of claim 41, wherein the solvent less polar than water is propylene carbonate.

46. The method of claim 41, wherein the method operation of sputter etching a portion of a dielectric film disposed over a substrate includes,
forming an argon based plasma.

47. The method of claim 41, wherein the method operation of applying a wet etchant including a solvent less polar than water to remove a remaining portion of the dielectric film includes,
maintaining the wet etchant at a temperature between −10 C and 50 C.
